(19) United States
(12) Patent Application Publication
(10) Pub. No.: US 2013/0130648 A1
(43) Pub. Date: May 23, 2013

(54) PROVIDING SUPPORT TO A USER

(71) Applicants: Kamran J. Tadjeran, Citrus Heights, CA (US); Srinivasan Karamadai, San Franscisco, CA (US); Thomas Tripp, El Dorado Hills, CA (US)

(72) Inventors: Kamran J. Tadjeran, Citrus Heights, CA (US); Srinivasan Karamadai, San Franscisco, CA (US); Thomas Tripp, El Dorado Hills, CA (US)

(21) Appl. No.: 13/302,803

(22) Filed: Nov. 22, 2011

(51) Int. Cl. H04W 4/12; H04W 12/00

(52) U.S. Cl. 455/410; 455/413

(57) ABSTRACT

A system for providing support to a user, the system comprising a server, the server communicatively coupled to a number of mobile devices, in which the server receives a number of sets of voice messages and configuration data from the mobile devices and causes the voice messages and configuration data to be routed to a number of support providers. A method of providing support to a user, the method comprising receiving a data packet from a mobile device containing a voice message and appended user specific configuration data, the voice message containing a service request from the user; routing the voice message and appended user specific configuration data to a customer service provider; and responding to the user's service request.

### BACKGROUND

Many companies maintain on-site personnel that provide various services to employees of the company and consumers. As advanced and new mobile technologies become more ubiquitous, the possibility of providing those services via a mobile device have arisen. Mobile devices such as smart phones provide a user with the ability to input and transmit data via voice and text.

### BRIEF DESCRIPTION OF THE DRAWINGS

The accompanying drawings illustrate various examples of the principles described herein and are a part of the specification. The illustrated examples do not limit the scope of the claims.

FIG. 1 is a block diagram of a system for providing support to a user according to one example of the principles described herein.

FIG. 2 is a block diagram of a system for providing support to a user according to another example of the principles described herein.

FIG. 3 is a flowchart showing a method of providing support to a user according to one example of principles described herein.

FIG. 4 is a flowchart showing a method of requesting support from a support center according to one example of principles described herein.

Throughout the drawings, identical reference numbers designate similar, but not necessarily identical, elements.

### DETAILED DESCRIPTION

The ability to send a text message on a mobile device has its limits. Specifically, mobile devices have become smaller in size and as a result the user interfaces used to input information has also decreased in size. These issues associated with entering data are further exacerbated when a user is mobile. It becomes increasingly more difficult to properly and safely enter in and transmit this data when the user is engaged in driving or while the user is walking. It is therefore becoming increasingly difficult for a user to communicate with a customer service provider, for example, while engaged in these and other activities.

It is also difficult for a user to communicate with customer service personnel in real-time using voice communication such as a phone call. For example, a user may not have time to engage in a conversation with a support provider. Additionally, the user may not be able, at that time, to provide the support provider with the information that he or she would use to provide the service. This information could include a product number, a serial number, or account number among others. Therefore, receiving support services while on a phone call also has its disadvantages.

The present system provides support to a user with a system comprising a server, the server communicatively coupled to a number of mobile devices, in which the server receives a number of sets of voice messages and configuration data from the mobile devices and causes the voice messages and configuration data to be routed to a number of support providers. The present method of providing support to a user comprises receiving a data packet from a mobile device containing a voice message and appended user specific configuration data, the voice message containing a service request from the user, routing the voice message and appended user specific configuration data to a customer service provider; and responding to the user's service request.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “service provider,” “customer service provider,” or “customer service personnel” is meant to be understood broadly as any person, group of persons, or entity that provides services to a user. In one example, the service provider may be providing services to a consumer of a product. In another example, the service provider may provide services to a number of other users who are not consumers of a product but are instead employees within a company.

Additionally, in the present specification and in the appended claims, the term “user” is meant to be understood broadly as any person using a mobile device.

Further, in the present specification and in the appended claims the term “mobile device” is meant to be understood broadly as any computing device capable of being operated by a user while the user is mobile. A mobile device may include mobile computers, mobile phones including smartphones, pagers, tablet computers, and personal digital assistants among others.

Still further, in the present specification and in the appended claims the term “voice message” is meant to be understood broadly as any recording of the voice of a user. In one example, the voice message may be a voicemail message that can be sent over a voice network. In another example, a voice message may be a voce recording of a user and may be in a format that is capable of being sent from a mobile device.

Even further, in the present specification and in the appended claims the term “text message” is meant to be understood broadly as any message that is represented by a written language. In one example, the text message may be a message created on a mobile device. In another example, the text message may be a message created on a mobile device and capable of being sent over a network using hypertext transfer protocol (HTTP) and hypertext transfer protocol secure (HTTPS). In another example, the text message may be a message created on a mobile device and capable of being sent over a network using Short Message Service (SMS).

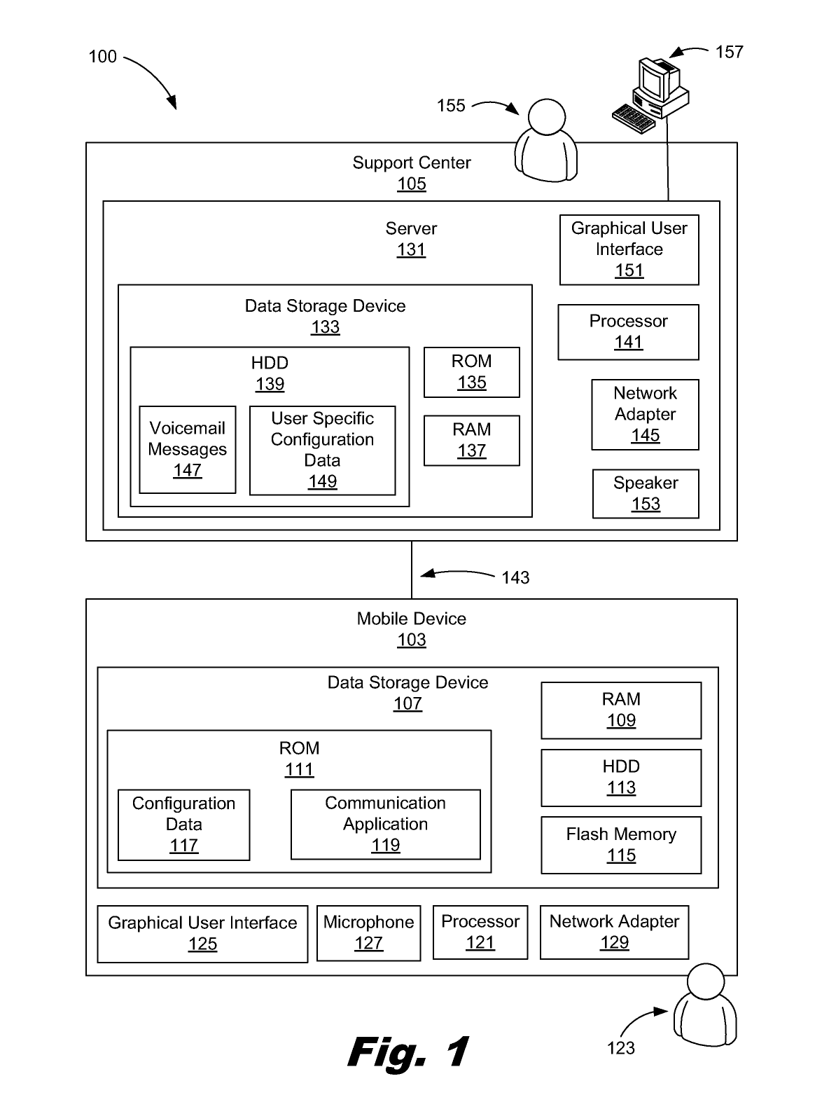

Turning now to FIG. 1, a system (100) for providing support to a user according to one example of the principles described herein is shown. The system (100) may comprise any number of mobile devices (103) communicatively coupled to a support center (105). The system may comprise any type of mobile devices (103) as described above and these mobile devices (103) may be communicatively coupled to the support center (105) via a wired or wireless connection. In one example, the mobile devices (103) may communicate with the support center (105) over a cellular network using a radio link similar to that used with cellular phones. In other examples, the mobile device (103) may communicate with the support center (105) using a push-to-talk or push-to-talk over cellular system.

As briefly mentioned above, the mobile device (103) may include mobile computers, mobile phones, smartphones, tablet computers, personal digital assistants and tablet computers, among others. The mobile device may further include a data storage device (107). The data storage device (107) may include various types of memory modules, including volatile and nonvolatile memory. For example, the data storage device (107) of the present example includes Random Access Memory (RAM) (109), Read Only Memory (ROM) (111), Hard Disk Drive (HDD) memory (113), and flash memory (115). Many other types of memory are available, and the present specification contemplates the use of any type of data storage device (107) as may suit a particular application of the principles described herein. In certain examples, different types of memory in the data storage device (107) may be used for different data storage needs. In certain examples a processor (121) may boot from ROM (111), maintain nonvolatile storage in the HDD memory (113) or flash memory (115), and execute program code stored in RAM (109).

As will be discussed later the data storage device (107) may store configuration data (117) and a communication application (119) used by a user (123) of the mobile device (103) to communicate with the support center (105). Although the configuration data (117) is shown to be stored on the ROM (111) memory, the configuration data (117) may be stored on any form of memory within the mobile device (103). Similarly, although the communication application (119) is shown to be stored on the ROM (111) memory, the communication application (119) may be stored on any form of memory within the mobile device (103).

The mobile device may also comprise a processor (121). The processor (121) may include hardware architecture that retrieves executable code from the data storage device (107) and executes the executable code. In an example, the executable code may, when executed by the processor (121), cause the processor (121) to implement at least the functionality of uploading, to the support center (105), a data package using the communication application (119). Further, in an example, the executable code may, when executed by the processor (121), cause the processor (121) to implement at least the functionality of appending user specific configuration data (117) to the data package sent to the support center (105) by, for example, using the communication application (119). In the course of executing code, the processor (121) may receive input from and provide output to any of the hardware units included in the mobile device (103).

The data storage device (107) may also store an audio file generated by the user (123). As will be discussed later, the user (123) may, through the use of a microphone (127), record a voice message detailing the user's (123) issue and need for support. The voice message may be sent to the support center (105) with the configuration data (117) appended thereto.

The user (123) may also be able to use the graphical user interface (125) to interact with and otherwise manipulate the recorded voice message. The graphical user interface (125) may also allow the user to enter in configuration data (117) into the mobile device (103).

The configuration data may comprise user specific information such as the user's (123) name, phone number, email address, and other contact information. Additionally, the configuration data (117) may comprise additional information that may identify the user (123) such as a password and username. In one example, the configuration data (117) may further include a product number, serial number, account number, and service verification information which the user (123) may use to receive information and support from support provider (155) at the support center (105). In another example, the user configuration information may include user preference information which will be used by the service provider (155) to respond to the user (123). In one example, the configuration data (117) is entered into the mobile device once. The configuration data (117) may be stored by the data storage device (107) until it is copied and attached to an outgoing data packet sent by the user (123) to the support center (105) as described above.

The mobile device (103) may further comprise a network adapter (129) that, as mentioned above, allows the mobile device to be connected to the support center (105). The network adapter (129) may allow the mobile device (103) to be wired or wirelessly connected to the support center (105). In one example, the network adapter (129) communicatively connects the mobile device (103) to the support center (105) by communicating over a cellular network. In other examples, the network adapter (129) communicatively couples the mobile device (103) to the support center (105) by a number of wired and wireless connections. Additionally, the mobile device (103) may contain hardware that supports network protocols such as hypertext transfer protocol (HTTP) and hypertext transfer protocol secure (HTTPS) and the mobile device (103) may send the configuration data and voice message using these types of protocols.

The support center (105) may receive data packets from individual users' (123) mobile devices (103) via a network connection (143) and, to facilitate this, may include a server (131) further comprising a network adapter (145). Therefore, in one example, the server (131) receives a data packet from a mobile device (103) via the network connection (143) and the network adapter (145). The sets of voice messages and configuration data (117) may be stored on a data storage device (133) as received voice messages (147) and user specific configuration data (149) files. Like the mobile device (103), the server (131) may contain hardware that supports network protocols such as hypertext transfer protocol (HTTP) and hypertext transfer protocol secure (HTTPS) and the server (131) may receive and send information such as the configuration data, voice message, and service request response using these types of protocols.

In one example, a processor (141), once the server (131) has received the data packet, may separate the voice message (147) from the user specific configuration data (149) and cause them to be stored in separate files on the data storage device (133). The processor (141) may further associate the individual voice messages (147) and user specific configuration data (149) with each other. In one example, the processor (141) may arrange the order in which the individual user (123) issues will be resolved. For example, the processor (141) may time stamp the individual data packets containing the voice messages (147) and user specific configuration data (149) such that each users' issue will be resolved in the order in which the support center (105) receives them.

In one example, the processor (141) may determine whether specific user specific configuration data (149) exists within the data packet and further distribute that data packet to a sub-set of support personnel (155) to address. The processor (141) may distribute the data packet to a support provider (155) based on, for example, the language the user (123) speaks, product type for which the user has requested support, and the type of support requested by the user (123), among others.

For example, if a data packet is received containing information regarding a serial number associated with a specific type of product produced by a specific company, the processor (141) may cause the data packet to be sent to a specific sub-set of support personnel (155) to resolve. In this example, the support provider (155) to which the data packet was sent may be specifically trained to address the issue concerning that specific product or similar products.

In another example, the processor (141) may determine that the user may need to have an appointment changed to a later time. A support provider (155) in charge of arranging that user's calendar may be defined in the user specific configuration data (149). The support provider (155) responsible for calendaring the user's daily events will then address this issue appropriately.

The processor (141) may, previous to routing the voice message (147) and configuration data (149) to the support provider (155), determine if the user (123) has authorization to receive support from support personnel (155). The processor (141) may determine if certain authorizing data is included in the configuration data (149) and, if so, may forward the voice message (147) and configuration data (149) to the appropriate support provider (155) who is capable of addressing the user's (123) issue. When appropriate authorization data is not present within the configuration data (149), the processor may, in one example, send an automatic response to the user's (123) mobile device (103) indicating that sufficient authorization data has not been presented.

The data storage device (133) of the server (131) may include various types of memory modules, including volatile and nonvolatile memory. For example, the data storage device (133) of the present example includes Random Access Memory (RAM) (137), Read Only Memory (ROM) (135), and Hard Disk Drive (HDD) memory (139). Many other types of memory are available, and the present specification contemplates the use of any type of data storage device (133) as may suit a particular application of the principles described herein. In certain examples, different types of memory in the data storage device (141) may be used for different data storage needs. In certain examples a processor (141) may boot from ROM (135), maintain nonvolatile storage in the HDD memory (139), and execute program code stored in RAM (137).

In one example, the voice messages (147) may be stored on Hard Disk Drive (HDD) memory (113). However, in the present specification, the voice messages (147) may be stored on any form of memory capable of, at least temporarily, storing the voice messages (147) until support personnel (155) have accessed each one and addressed the specific users' concerns. Similarly, the sets of user specific configuration data (149) may be stored on Hard Disk Drive (HDD) memory (113). Again, the present specification contemplates, however, that the user specific configuration data (149) may be stored on any form of memory capable of, at least temporarily, storing the configuration data (149).

Once a voice message (147) and user specific configuration data (149) have been received by the support center's (105) server (131), the individual user's issue or issues may be resolved by support personnel (155). In one example, the support provider (155) may access a specific user's voice message and its accompanying user specific configuration data via a graphical user interface (151). In another example, the support provider (155) may first review the user's configuration data to determine if the user is authorized to receive support from the support center (105). For example, the support provider (155) may review the user specific configuration data to determine if a product warranty is still valid, a service support contract is still in force, and whether or not the provided username and password is valid, among others.

Once the support provider (155) has determined that the user is permitted to receive support from the support center (105) the support provider (155) may then, through the graphic user interface (151), access the accompanying voice message (147) and listen to the voice message (147) through, for example, a speaker (153) associated with the server (131). After listening to the voice message (147), the support provider (155) may send a text or email to the user (123) indicating that a solution has been found or suggest that certain actions be performed to help resolve the user's (123) issue. To facilitate this, the graphical user interface (151) may prompt the support provider (155) to enter in text within the graphical user interface (151) and may automatically send that text or email to the user (123) using the text number or email address provided by the user in the user specific configuration data (149). In one example, the processor (141) may propagate the user specific configuration data (149) onto the graphical user interface (151) such that the support provider (155) does not manually enter in any information except that information entered in response to the user's (123) issue. Therefore, the system (100) allows support personnel (155) to hear the user's issue, address that issue appropriately, and send confirmation of the issue being resolved or further instructions for the user (123) to follow in order to resolve the issue.

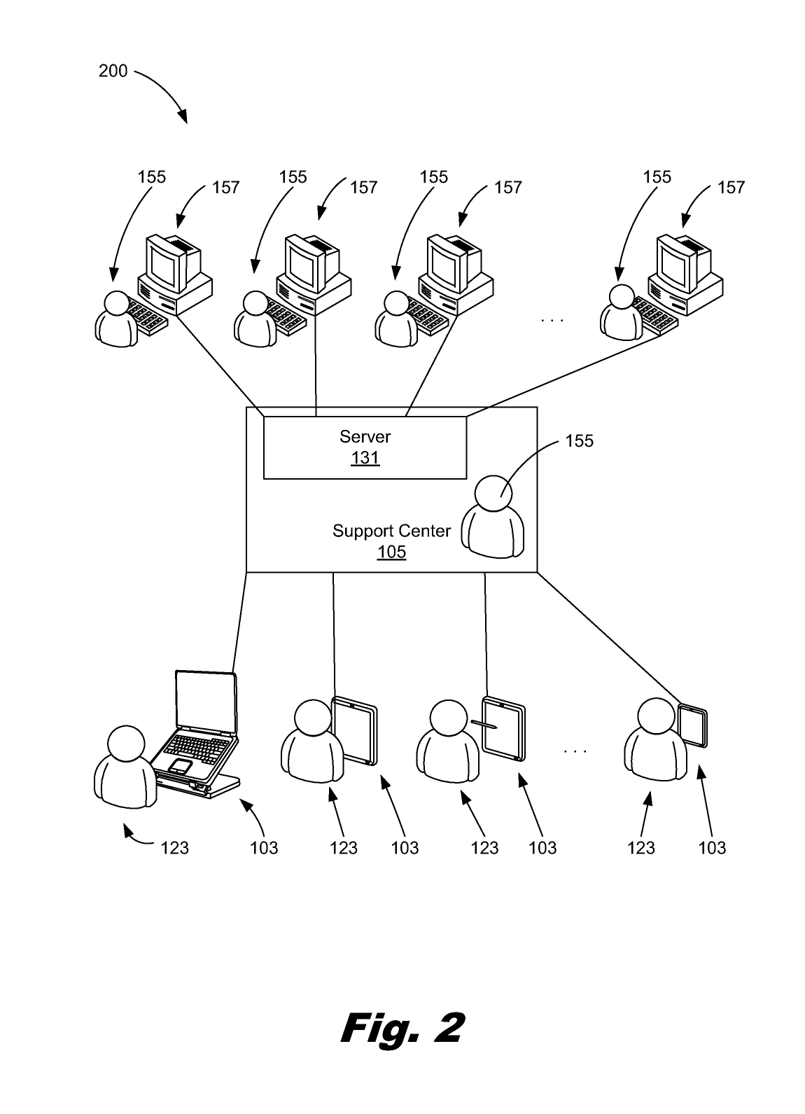

FIG. 2 is a block diagram of a system (200) for providing support to a user according to another example of the principles described herein. As shown in FIG. 2, the present specification contemplates that a number of service personnel (155) may be in communication with the server (131) via a network of computers (157). Additionally, the present specification contemplates that any number of users (123), through a respective mobile device (103), will be allowed to upload any number of data packets to the server (131) as described above.

For example, the support center (105) may include any number of support personnel (155) each communicating with the server (131) via a computer (157); each computer (157) comprising a network adapter, a graphical user interface, a speaker, a processor, and a data storage device similar to the server (131) discussed above. The support personnel (155) may or may not be physically located at the support center (105) and each computer (155) may or may not be physically located in the same place as the server (131).

The system (FIG. 1, 100) described above therefore allows a user to automatically attach specific user information to a voice message containing the user's issue to be resolved. The system (FIG. 1, 100) also allows the user (FIG. 1, 123) to send that information to a server (FIG. 1, 131) where support personnel (155) can address the user's concerns. A mobile user (FIG. 1, 123) will experience less effort in attempting to have an issue resolved. For example, the user (FIG. 1, 123) may record a voice message (FIG. 1, 147) and have the communication application (FIG. 1, 119) send the appropriate information to the support center (FIG. 1, 105) for resolution of the issue. The user (FIG. 1, 123) would then be able to address any response from the support center (FIG. 1, 105) at a later time while being able to conduct other business. In the meantime, the issue may be addressed by the support personnel (FIG. 1, 155). The user (FIG. 1, 123) may also be allowed to get an issue resolved without texting or otherwise being preoccupied while, for example, driving his or her car or walking. This avoids situations where a preoccupied user (FIG. 1, 123) can injure him or herself by diverting his or her attention to the mobile device (FIG. 1, 103) instead of driving or walking.

Via the system (FIG. 1, 100), the support personnel (FIG. 1, 155) may be better able to address the individual user's (FIG. 1, 123) issues. Specifically, because the user has provided a voice message (FIG. 1, 147) detailing the specific issue, a support provider (FIG. 1, 155) may be able to address the issue without having to keep the user on the line, taking up both the user's time as well as the support provider's. Because of the asynchronous nature of the issue resolution process described above, the support provider (FIG. 1, 155) may also be free to research the relatively more complex issues without monopolizing the user's time.

The user also does not have to worry that a discrepancy may arise in the message being received such as in the situation where voice to text is used. Because there is no attempt to convert the audio information describing the user's issue into text, the message retains the fidelity of the content thereby producing a more accurate message.

Additionally, with the inclusion of the user specific configuration data (FIG. 1, 149) appended to the voice message (FIG. 1, 147) the support provider (FIG. 1, 155) may go directly into resolving the individual users' issues without having to expend time gathering this information. As a result, the user (FIG. 1, 123) also does not provide information that, at least at the time, he or she wouldn't be readily able to provide over the phone without reference to other documentation such as a product number or serial code.

Further, as a result of being able to address the users' issues on their own time frame, the number of cases a member of the support personnel (FIG. 1, 155) can resolve will increase due to the ability of the support provider (FIG. 1, 155) to multi-task. For example, the support provider (FIG. 1, 155) using the present system (FIG. 1, 100) may be able to finish up resolving one user's issue and simultaneously begin addressing another issue.

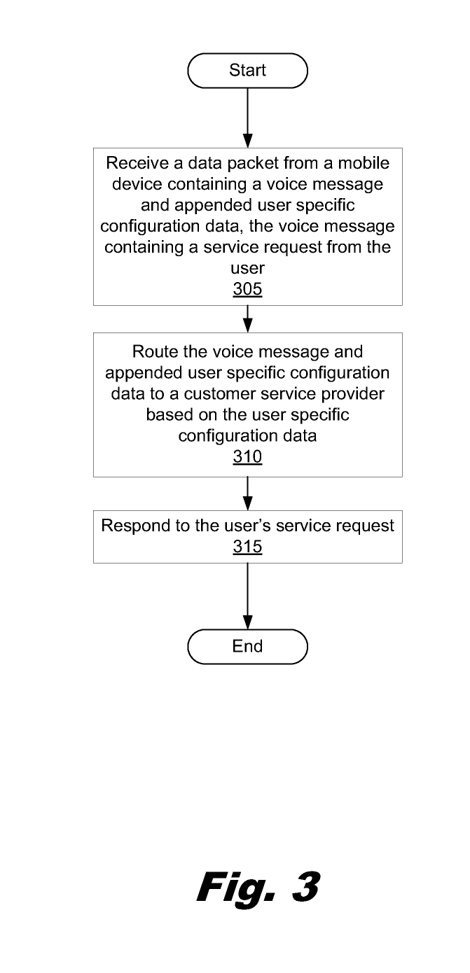

FIG. 3 is a flowchart showing a method of providing support to a user (FIG. 1, 123) according to one example of principles described herein.

The process may begin with the support center (FIG. 1, 105) receiving (Block 305) a data packet from a mobile device (FIG. 1, 103) containing user specific configuration data (FIG. 1, 149) and an appended voice message (FIG. 1, 147). The voice message (FIG. 1, 147) may be an audio file in which the audio is the recorded voice of the user (FIG. 1, 123) of the mobile device (FIG. 1, 103) verbally describing an issue or a service request the user (FIG. 1, 123) is requesting to be resolved.

The data packet containing user specific configuration data (FIG. 1, 149) and the appended voice message (FIG. 1, 147) may be routed (Block 310) to a customer service provider (FIG. 1, 155). The customer service provider (FIG. 1, 155) may then respond (Block 315) to the user's (FIG. 1, 123) service request as appropriate. In one example, the customer service provider (FIG. 1, 155) may listen to the voice message (FIG. 1, 147) and, using the configuration data (FIG. 1, 149), respond to the user (FIG. 1, 123) via a text message, an email, or a phone call, among others. The customer service provider (FIG. 1, 155) is aided by the system (FIG. 1, 100) described above where the system automatically propagates the user's specific configuration data (FIG. 1, 149) on to the graphical user interface (151) thereby allowing the customer service provider (FIG. 1, 155) to immediately address the user's service request. Consequently, the customer service provider (FIG. 1, 155) does not spend time either looking up this information on a database or calling the user (FIG. 1, 123) for the information.

In one example, the data packet received (Block 305) from the mobile device may be assigned or otherwise associated with a unique identification number. This identification number may be included in the text message or email sent to the user (FIG. 1, 123) when the customer service provider (FIG. 1, 155) responds (FIG. 3, 315) to the user's (FIG. 1, 123) service request. The text message or email sent to the user (FIG. 1, 123) may also include the user's (FIG. 1, 123) name, the name of the customer service provider (FIG. 1, 155), a picture of a product the user (FIG. 1, 123) may be requesting support on, account information, and a unique case number among others.

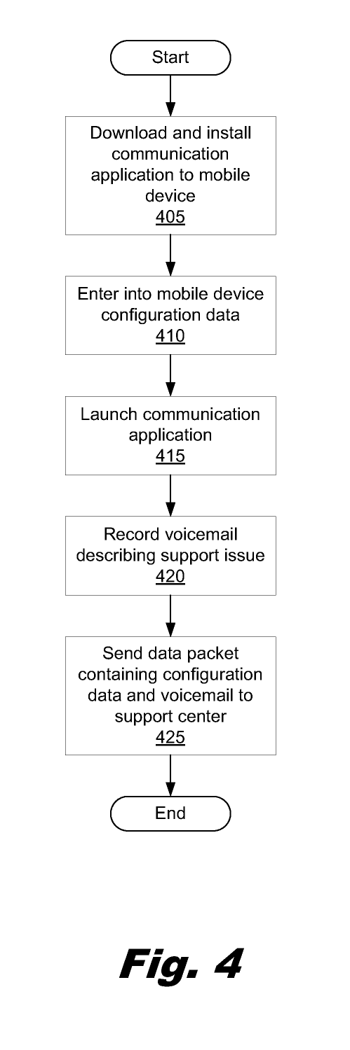

FIG. 4 is a flowchart showing a method of requesting support from a support center according to one example of principles described herein. The process may start with the user (FIG. 1, 123) downloading and installing (Block 405) a communication application (FIG. 1, 119) to the mobile device (FIG. 1, 103). As briefly discussed above, the communication application (FIG. 1, 119), when initiated, may allow the user (FIG. 1, 123) to record a voice message that describes the users (FIG. 1, 123) issue to be resolved by the customer support provider (FIG. 1, 155). The communication application (FIG. 1, 119) may also allow the user (FIG. 1, 123) to review, edit, re-record, and send the voice message to the support center (FIG. 105).

After the communication application has been downloaded and installed (Block 405), the user (FIG. 1, 123) may be allowed to enter (Block 410) into the mobile device (FIG. 1, 103) user specific configuration data (FIG. 1, 117). The configuration data may comprise user specific information such as the user's (FIG. 1, 123) name, phone number, email address, and other contact information. Additionally, the configuration data (FIG. 1, 117) may comprise additional information that may identify the user (FIG. 1, 123) such as a password and username. In one example, the configuration data (FIG. 1, 117) may further include a product number, serial number, account number, and service verification information which the user (FIG. 1, 123) may use to receive information and support from support provider (FIG. 1, 155) at the support center (FIG. 1, 105). In another example, the user configuration information may include user preference information which will be used by the service provider to respond to the user (FIG. 1, 123). In one example, the configuration data (FIG. 1, 117) is entered into the mobile device once. The configuration data (FIG. 1, 117) may be stored by the data storage device (FIG. 1, 107) until it is copied and attached to an outgoing data packet sent by the user (FIG. 1, 123) to the support center (FIG. 1, 105) as described above.

After the configuration data (FIG. 1, 117) is entered (block 410) into the mobile device (FIG. 1, 103), the user (FIG. 1, 103) may use the communication application (Block 415) to record (Block 420) the issue the user (FIG. 1, 123) would like the customer support provider (FIG. 1, 155) to resolve. The user (FIG. 1, 123) may then send or cause to be sent (Block 425) a data packet containing the configuration data (FIG. 1, 117) and the recorded voice message to the support center (FIG. 1, 105).

The specification and figures describe a system (FIG. 1, 100) and method for providing support to a user (FIG. 1, 123) of a mobile device (FIG. 1, 103). The system (FIG. 1, 100) and method allows a user (FIG. 1, 100) of a mobile device (FIG. 1, 103) to enter in configuration data (FIG. 1, 117) into his or her mobile device (FIG. 1, 103) and append that information to a voice message sent to a support provider (FIG. 1, 155). The support provider (FIG. 1, 155) may then listen to the voice message and respond to the user (FIG. 1, 123). The configuration data (FIG. 1, 149) is used in responding to the user (FIG. 1, 123) using information automatically provided to the user. This system and method for providing support to a user of a mobile device may have a number of advantages. Specifically, the customer service provider (FIG. 1, 155) may be able to address the issue without having to keep the user (FIG. 1, 123) on the phone. Additionally, because the user (FIG. 1, 123) sends a voice message to the customer support provider (FIG. 1, 155), the customer support provider (FIG. 1, 155) may be allowed more time to research issues the user (FIG. 1, 123) may have and may further be allowed to multi-task by handling a number of user (FIG. 1, 123) service requests at one time. Still further, the use of a voice message allows the customer support provider (FIG. 1, 155) to listen and re-listen to the voice message without the voice message being converted into text and potentially loosing some fidelity.

The preceding description has been presented to illustrate and describe examples of the principles described. This description is not intended to be exhaustive or to limit these principles to any precise form disclosed. Many modifications and variations are possible in light of the above.

What is claimed is:

1. A system for providing support to a user, the system comprising:
a server, the server communicatively coupled to a number of mobile devices,
in which the server receives a number of sets of voice messages and configuration data from the mobile devices and causes the voice messages and configuration data to be routed to a number of support providers.

2. The system of claim 1, in which the server receives the voice messages and configuration data via a hypertext transfer protocol secure (HTTPS) request.

3. The system of claim 1, in which the server further comprises a processor to route and queue the voice messages and configuration data.

4. The system of claim 1, in which the configuration data comprises the user's name, the user's phone number, the user's email address, a password, a username, a product number, a serial number, an account number, service verification information, or combinations thereof.

5. The system of claim 1, in which the server further comprises a processor to determine whether the configuration data includes valid authorizing data to allow the user to receive support from the support providers.

6. The system of claim 1, in which the support providers may listen to the voice message and provide support to the user via a text message.

7. A mobile device for requesting support from a support provider, the mobile device comprising:
a processor that executes a communication application to record a voice message from a user and accept configuration data from the user,
in which the processor appends the configuration data to the voice message and sends the configuration data and voice message to the support provider.

8. The apparatus of claim 7, in which the communication application prompts the user to enter in configuration data prior to recording the voice message.

9. The apparatus of claim 7, in which the configuration data comprises the user's name, the user's phone number, the user's email address, a password, a username, a product number, a serial number, an account number, service verification information, or combinations thereof.

10. The apparatus of claim 7, in which the mobile device further comprises a data storage device and in which the configuration data is stored on the data storage device for use by the communication application.

11. A method of providing support to a user, the method comprising:
receiving a data packet from a mobile device containing a voice message and appended user specific configuration data, the voice message containing a service request from the user;
routing the voice message and appended user specific configuration data to a customer service provider based on the user specific configuration data; and
responding to the user's service request.

12. The method of claim 11, in which the voice message and appended user specific configuration data is routed to a customer service provider based additionally on the time in which the voice message and appended user specific configuration data was received.

13. The method of claim 11, in which routing the user specific configuration data to a customer service provider further comprises propagating the user specific configuration data onto a graphical user interface and prompting a customer service provider to respond to the user's service request.

14. The method of claim 11, in which the configuration data comprises the user's name, the user's phone number, the user's email address, a password, a username, a product number, a serial number, an account number, service verification information, or combinations thereof.

15. The method of claim 11, further comprising determining via the configuration data if the user is authorized to receive support from a customer service provider.
